(19) United States
(12) Patent Application Publication
(10) Pub. No.: US 2019/0365132 A1
(43) Pub. Date: Dec. 5, 2019

(54) Strainer Arrangement

(71) Applicant: Talmu NY LLC, Brooklyn, NY (US)

(72) Inventor: Joshua Farkas, Brooklyn, NY (US)

(73) Assignee: Talmu NY LLC, Brooklyn, NY (US)

(21) Appl. No.: 15/991,123

(22) Filed: May 29, 2018

(51) Int. Cl. A47J 19/00; A47J 43/24; A47J 36/20; A47J 27/12

(52) U.S. Cl. CPC A47J 19/005; A47J 27/12; A47J 36/20; A47J 43/24

(57) ABSTRACT

The present disclosure provides a strainer arrangement. The strainer arrangement comprises a first colander having a substantially rigid rim and at least one handle member with an aperture formed therein. The strainer arrangement also comprises a second colander having a substantially rigid rim and at least one handle member with a tab projecting from a bottom side thereof. The first colander and the second colander are of substantially same shape for stacking of the second colander into the first colander such that when stacked, the tab in the at least one handle member of the rim of the second colander engages with the aperture in the at least one handle member of the rim of the first colander for releasably locking the first colander and the second colander.

### BACKGROUND OF THE INVENTION

### 1. Field of the Invention

The present disclosure generally relates to strainers, and more particularly, relates to a strainer arrangement with multiple collapsible colanders stacked into each other.

### 2. Description of the Related Art

Kitchen equipment, such as strainers, are often large in size. Some kitchens, for example, restaurant kitchens, may even require more than one strainer so that the multiple strainers can be used simultaneously for preparation of a large number of food items at the same time, or for straining of different sized items. However, these strainers, owing to their large sizes, can become difficult to handle and store. Moreover, being such large equipment, the known strainers do not provide any additional function other than the purpose of draining water from items placed therein. Thus, sometimes it may become a difficult choice for a consumer to keep multiple strainers in their kitchens because of the extra burden that it may add to the, generally, already limited space in the kitchen.

Applicant believes that a related reference corresponds to U.S. Pat. No. 9,089,237 (hereinafter referred to as “the '237 patent”), which discloses a collapsible colander that includes a bowl portion and a base portion. The bowl portion is made from a plurality of triangular panels that are pivotally secured together around a central pivot, and slidably joined two adjacent panels by sliding fasteners. Mating fastener components secured to the end panels permit the bowl to be assembled into a bowl shape. The base is a continuous band that is positioned in a generally circular configuration underneath of the bowl to support the bowl when the colander is in use. When the colander is collapsed, the collapsed bowl fits within the substantially flattened base. The collapsible colander of the '237 patent does not provide for any means to arrange multiple colanders together for storage purposes or the like, or provide any novel application thereof.

Other documents describing the closest subject matter provide for a number of more or less complicated features that fail to solve the problems described above in an efficient and economical way. None of the documents suggest the novel features of the present disclosure.

### SUMMARY OF THE INVENTION

It is one of the main objectives of the present disclosure to provide a strainer arrangement having multiple collapsible colanders.

It is another objective of the present disclosure to provide a strainer arrangement with multiple colanders stacked into each other.

It is yet another objective of the present disclosure to provide a strainer arrangement in which multiple colanders are releasably locked with each other, so as to be compact and easily stored.

The present disclosure provides for a strainer arrangement. The strainer arrangement comprises a first colander comprising a substantially rigid rim. The rim of the first colander provides at least one handle member. The at least one handle member of the rim of the first colander have an aperture formed therein. The strainer arrangement also comprises a second colander comprising a substantially rigid rim. The rim of the second colander provides at least one handle member. The at least one handle member of the rim of the second colander have a tab projecting from a bottom side thereof. The first colander and the second colander are of substantially same shape for stacking of the second colander into the first colander such that when stacked, the tab in the at least one handle member of the rim of the second colander engages with the aperture in the at least one handle member of the rim of the first colander for releasably locking the first colander and the second colander.

Further objectives of the invention will be brought out in the following part of the specification; wherein detailed description is for the purpose of fully disclosing the invention without placing any limitations thereon.

### BRIEF DESCRIPTION OF THE DRAWINGS

With the above and other related objectives in view, the invention consists in the details of construction and combination of parts, as will be more fully understood from the following description, when read in conjunction with the accompanying drawings in which:

FIG. 1 illustrates a diagrammatic perspective view of a strainer arrangement 100 with a first colander 102 and a second colander 104 shown in their respective collapsed configuration and releasably locked and stacked into each other, in accordance with one or more embodiments of the present disclosure;

FIG. 2 illustrates a diagrammatic perspective view of the strainer arrangement 100 with the second colander 104 being lifted to be partially separated from the first colander 102, with the first colander 102 and the second colander 104 shown in their respective collapsed configuration, in accordance with one or more embodiments of the present disclosure;

FIG. 3 illustrates a diagrammatic perspective view of the strainer arrangement 100 with the first colander 102 and the second colander 104 separated from each other and shown in their respective collapsed configuration, in accordance with one or more embodiments of the present disclosure;

FIG. 4 illustrates a diagrammatic perspective view of the strainer arrangement 100 with the first colander 102 and the second colander 104 separated from each other and shown in their respective open configuration, in accordance with one or more embodiments of the present disclosure;

FIGS. 5A-5B illustrate top perspective views of the first colander 102 and the second colander 104 respectively showing their corresponding inner surfaces, in accordance with one or more embodiments of the present disclosure; and

FIGS. 6A-6B illustrate bottom perspective views of the first colander 102 and the second colander 104 respectively showing their corresponding outer surfaces, in accordance with one or more embodiments of the present disclosure;

FIG. 7 illustrates a diagrammatic perspective view of the strainer arrangement 100 with a first colander 102 in open configuration and the second colander 104 in collapsed configuration, and locked with each other, in accordance with one or more embodiments of the present disclosure; and

FIG. 8 illustrates a diagrammatic perspective view of the strainer arrangement 100 with both the first colander 102 and the second colander 104 in open configuration, with the second colander 104 inverted and locked with the first colander 102, in accordance with one or more embodiments of the present disclosure.

### DETAILED DESCRIPTION OF THE EMBODIMENTS OF THE INVENTION

Illustrative embodiments of the present disclosure are described below. The following explanation provides specific details for a thorough understanding of and enabling description for these embodiments. One skilled in the art will understand that the invention may be practiced without such details. In some instances, well-known structures, processes and functions have not been shown or described in detail to avoid unnecessarily obscuring the description of the embodiments.

It shall be noted that unless the context clearly requires otherwise, throughout the description, the words “comprise,” “comprising,” “include,” “including,” and the like are to be construed in an inclusive sense as opposed to an exclusive or exhaustive sense; that is to say, in the sense of “including, but not limited to.” Words using the singular or plural number also include the plural or singular number, respectively while adhering to the concepts of the present disclosure. Furthermore, references to “one embodiment” and “an embodiment” are not intended to be interpreted as excluding the existence of additional embodiments that also incorporate the recited features.

The embodiments as described herein are subject to many variations. It is understood that various omissions and substitutions of equivalents are contemplated as circumstances may suggest or render expedient, but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

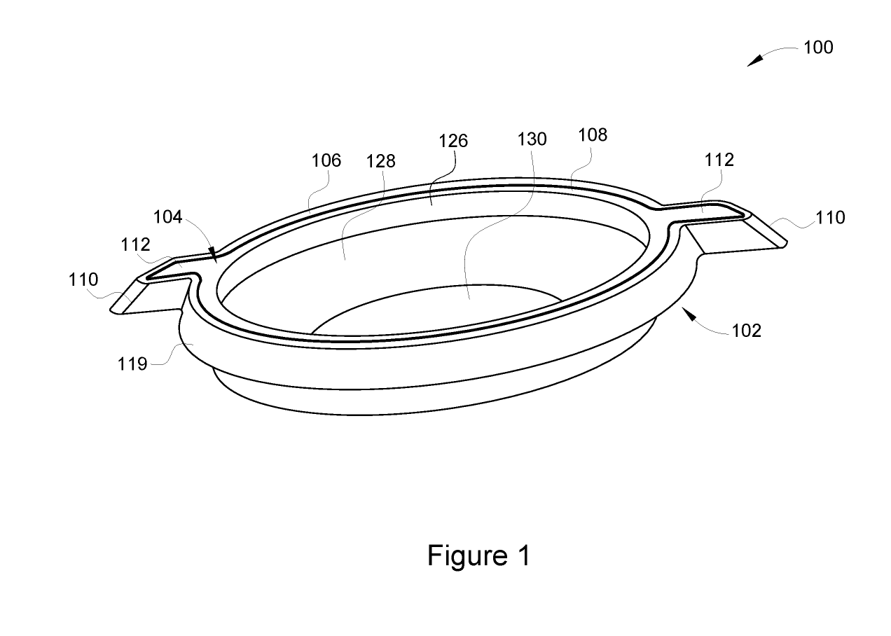

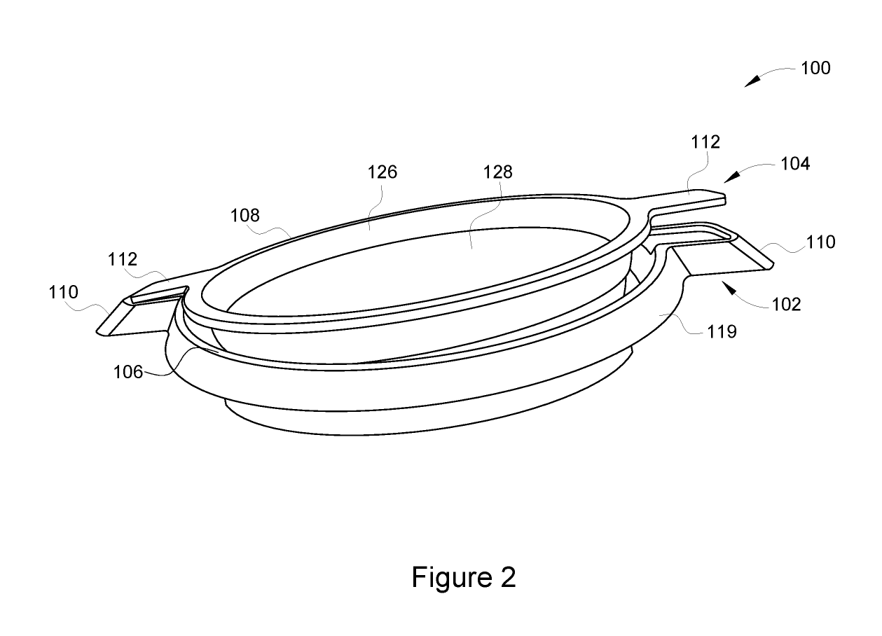

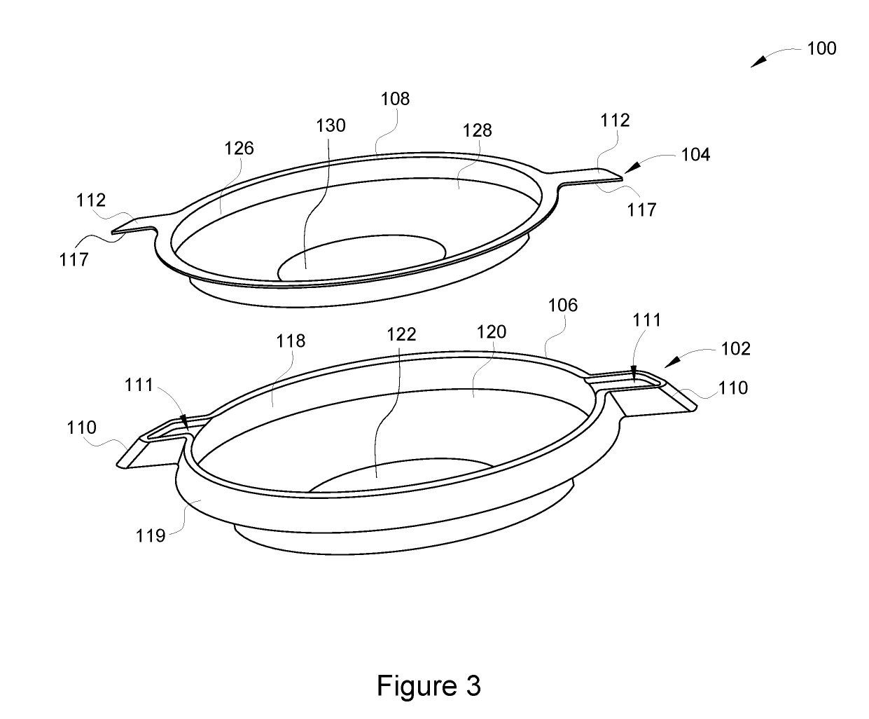

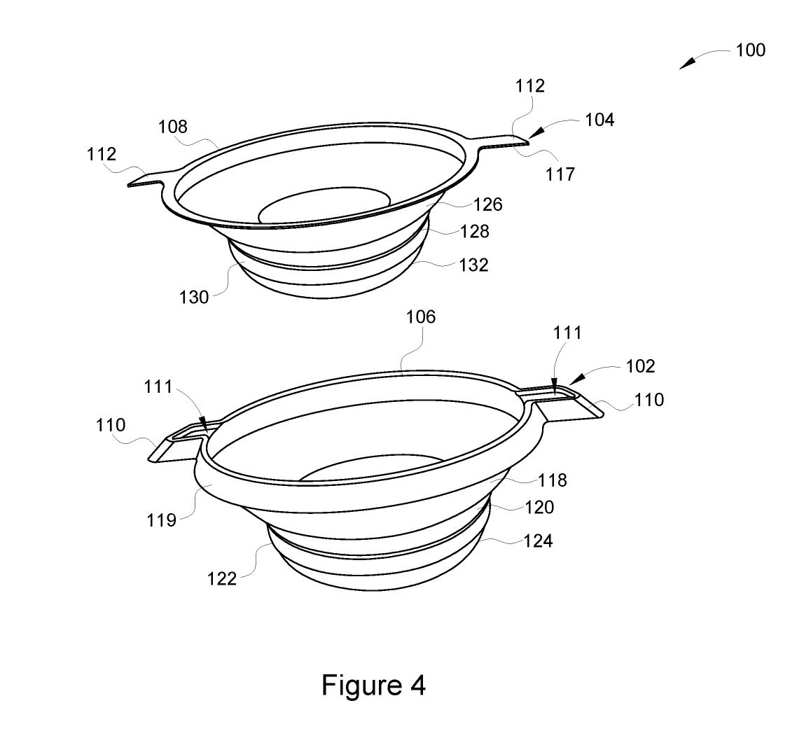

Referring to the drawings, FIG. 1 illustrates a diagrammatic view of a strainer arrangement (referred by the numeral 100), in accordance with one or more embodiments of the present disclosure. The strainer arrangement 100 of the present disclosure includes multiple colanders which are stacked on to each other. In the present embodiments, the strainer arrangement 100 is shown to include two colanders, namely a first colander 102 and a second colander 104. In the illustration of FIG. 1, the first colander 102 and the second colander 104 are shown to be in their respective collapsed configuration. Further, the first colander 102 and the second colander 104 are shown to be stacked into and locked with each other. In the illustration of FIG. 2, the first colander 102 and the second colander 104 are shown to be in their respective collapsed configuration; and the second colander 104 is shown to be slightly lifted and thus partially separated from the first colander 102. In the illustration of FIG. 3, the first colander 102 and the second colander 104 are shown to be in their respective collapsed configuration; and the second colander 104 is shown to be separated from the first colander 102. In the illustration of FIG. 4, the first colander 102 and the second colander 104 are shown to be in their respective open configuration; and the second colander 104 is shown to be separated from the first colander 102.

Referring to FIGS. 1-4 in combination, the first colander 102 includes a rim 106 and the second colander 104 includes a rim 108. The rim 106 of the first colander 102 and the rim 108 of the second colander 104 are made of substantially rigid material, such as hard plastic or the like. The rims 106 and 108 are substantially circular in nature, with the rim 106 having a slightly larger diameter than the rim 108. Further it may be seen that the rims 106 and 108 extend substantially in a radial direction to provide thickness thereto, in order for the second colander 104 to be able to sit on the first colander 102 when stacked onto each other. Generally, the first colander 102 is larger in size as compared to the second colander 104 so as to enable stacking of the second colander 104 into the first colander 102. Further, as illustrated, the rim 106 of the first colander provides at least one handle member. In particular, the rim 106 of the first colander 102 provides two handle members 110. In the present examples, the handle members 110 are formed integrally with the rim 106. Similarly, the rim 108 of the second colander 104 provides at least one handle member. In particular, the rim 108 of the second colander 104 provides two handle members 112. In the present examples, the handle members 112 are formed integrally with the rim 108.

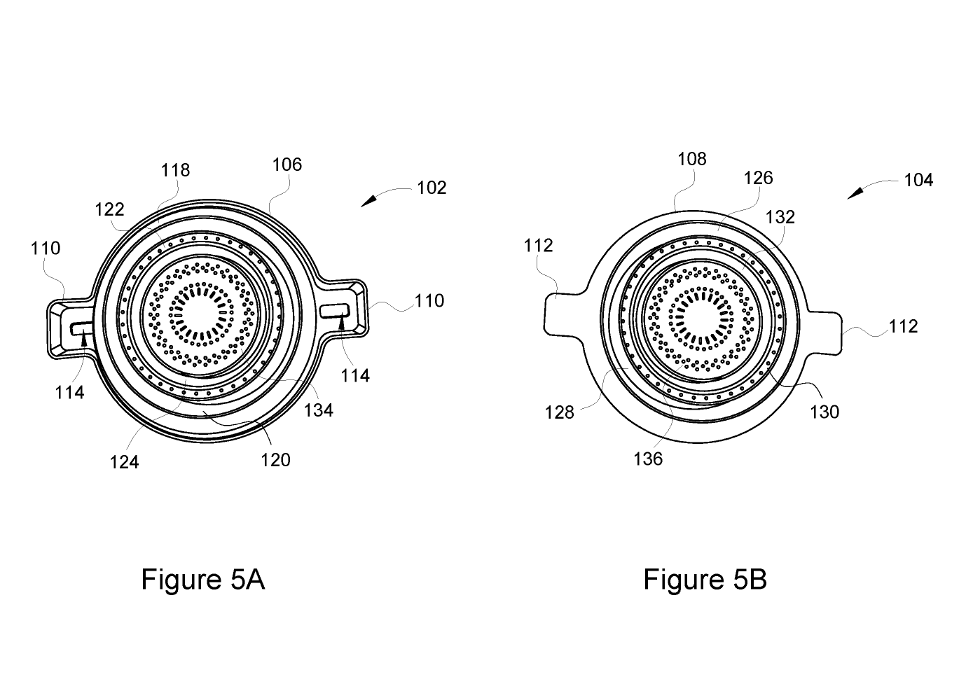

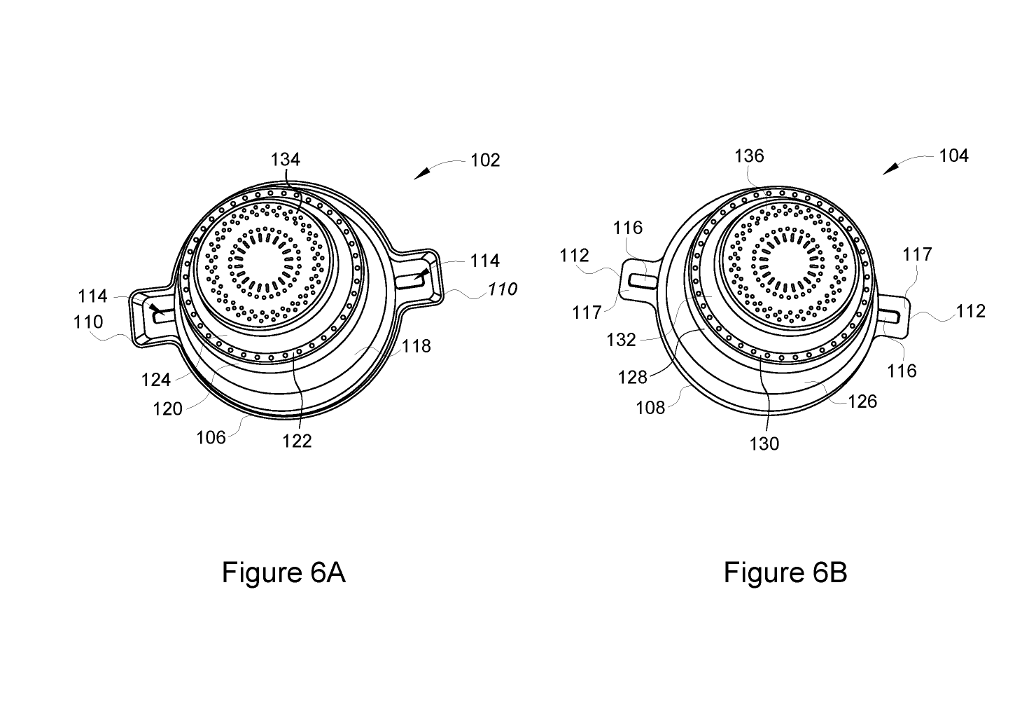

As illustrated more clearly in FIGS. 3 and 4, the handle members 110 of the rim 106 of the first colander 102 have corresponding apertures 114 formed therein. In particular, each of the handle members 110 may include depressions 111 and the apertures 114 are formed in the depressions 111. In some examples, only one of the two handle members 110 may have the aperture 114 formed therein, without any limitations (as further illustrated in FIGS. 5A and 6A). Further, as illustrated in FIG. 6B, the handle members 112 of the rim 108 of the second colander 104 have corresponding tabs 116 projecting from bottom sides 117 thereof. The tabs 116 in the second colander 104 may, generally, be in the same shape and size as the apertures 114 the first colander 102. In some examples, only one of the two handle members 112 may have the tabs 116 projecting therefrom, without any limitations.

As illustrated, the first colander 102 includes a first vertical wall 118 extending downwardly from the rim 106 thereof. The first vertical wall 118 may be made of same rigid material as the rim 106. As may be seen, the handle members 110 of the rim 106 of the first colander 102 are extending radially outwardly from the first vertical wall 118. In some examples, the first colander 102 may also include a rim wall 119 extending downwardly from the rim 106 at a distal end thereof and parallel to the first vertical wall 118. Further, the first colander 102 includes at least one flexible membrane supported and extending, downwardly and inwardly from the first vertical wall 118. In the present examples, the first colander 102 includes a first flexible membrane 120 supported and extending, downwardly and inwardly from the first vertical wall 118. A second vertical wall 122 is supported and extending downwardly from the first flexible membrane 120. The second vertical wall 122 may be made of same rigid material as the first vertical wall 118. Further, a second flexible membrane 124 is supported and extending, downwardly and inwardly from the second vertical wall 122. In one example, the first flexible membrane 120 and the second flexible membrane 124 may be supported from the corresponding vertical walls at three hinge point in order to allow the first flexible membrane 120 and the second flexible membrane 124 to fold and unfold, as desired. In an embodiment, the first flexible membrane 120 and the second flexible membrane 124 are formed of a porous material which is more flexible than the material used for forming the rim 106, the first vertical wall 118 or the second vertical wall 122. For example, the first flexible membrane 120 and the second flexible membrane 124 may be formed of cellulose material or the like. In an embodiment of the present disclosure, the first flexible membrane 120 and the second flexible membrane 124 are adapted to fold so as to dispose the first colander 102 into a collapsed configuration (as best shown in FIG. 3) and unfold to dispose the first colander 102 into an open configuration (as shown in FIG. 4 and further in FIGS. 5A-6B).

Further, as illustrated, the second colander 104 includes a first vertical wall 126 extending downwardly from the rim 108 thereof. The first vertical wall 126 may be made of same rigid material as the rim 108. As may be seen, the handle members 112 of the rim 108 of the second colander 104 are extending radially outwardly from the first vertical wall 126. Further, the second colander 104 includes at least one flexible membrane supported and extending, downwardly and inwardly from the first vertical wall 126. In the present examples, the second colander 104 includes a first flexible membrane 128 supported and extending, downwardly and inwardly from the first vertical wall 126. A second vertical wall 130 is supported and extending downwardly from the first flexible membrane 128. The second vertical wall 130 may be made of same rigid material as the first vertical wall 126. Further, a second flexible membrane 132 is supported and extending, downwardly and inwardly from the second vertical wall 130. In one example, the first flexible membrane 128 and the second flexible membrane 132 may be supported from the corresponding vertical walls at three hinge point in order to allow the first flexible membrane 128 and the second flexible membrane 132 to fold and unfold, as desired. In an embodiment, the first flexible membrane 128 and the second flexible membrane 132 are formed of a porous material which is more flexible than the material used for forming the rim 108, the first vertical wall 126 or the second vertical wall 130. For example, the first flexible membrane 128 and the second flexible membrane 132 may be formed of cellulose material or the like. In an embodiment of the present disclosure, the first flexible membrane 128 and the second flexible membrane 132 are adapted to fold so as to dispose the second colander 104 into a collapsed configuration (as best shown in FIG. 3) and unfold to dispose the second colander 104 into an open configuration (as shown in FIG. 4 and further in FIGS. 5A-6B).

Furthermore, the first colander 102 includes a base member 134 which is supported on the second flexible membrane 124 thereof. The base member 134 is connected to the second flexible membrane 124 throughout the length of circular periphery thereof. The base member 134 includes a convex or rounded portion that serves as the bottom of the first colander 102. The bottom of the base member 134 need not necessarily be rounded, but it facilitates drainage in the form of a colander and is a preferred shape in the form of a bowl. As illustrated in FIGS. 5A-6B, the base member 134 includes a plurality of holes (not labelled). The plurality of holes may include different shapes of holes which are arranged in a circular fashion. Similarly, the second colander 104 includes a base member 136 which is supported on the second flexible membrane 132 thereof. The base member 136 is connected to the second flexible membrane 132 throughout the length of circular periphery thereof. The base member 136 includes a convex or rounded portion that serves as the bottom of the second colander 104. The bottom of the base member 136 need not necessarily be rounded, but it facilitates drainage in the form of a colander and is a preferred shape in the form of a bowl. As illustrated in FIGS. 5A-6B, the base member 136 includes a plurality of holes (not labelled). The plurality of holes may include different shapes of holes which are arranged in a circular fashion. In some examples, as illustrated, horizontal portions of the second vertical wall 122 and the second vertical wall 130 may also include multiple holes (not labelled) arranged along the circular peripheries thereof, respectively (as illustrated in FIGS. 5A-6B). In one example, the holes in the first colander 102 may be of different size as compared to the holes in the second colander 104 such that the two colanders 102 and 104 may be utilized for straining of different sized items.

In an embodiment of the present disclosure, the first colander 102 and the second colander 104 are of substantially same shape for stacking of the second colander 104 into the first colander 102. When stacked, the handle members 112 sit inside the depressions 111 of handle members 110, and thereby the tabs 116 in the handle members 112 of the rim 108 of the second colander 104 engages with the apertures 114 in the handle members 110 of the rim 106 of the first colander 102. Such engagement allows for releasably locking the first colander 102 and the second colander 104, when stacked. It may be understood that the first colander 102 and the second colander 104 may later be separated when desired by pulling the second colander 104 out of the first colander 102 (as depicted in FIG. 2), as it may cause the disengagement of the corresponding tabs 116 from the apertures 114.

The straining arrangement 100 of the present disclosure may be stored in any desired manner. In one example, the first colander 102 and the second colander 104 may be locked with each other and disposed in collapsed configurations, to make the straining arrangement 100 compact for storage purposes and the like. In another example, the first colander 102 and the second colander 104 may be locked with each and disposed in open configurations, to make the straining arrangement 100 ready to be use. In yet another example, the first colander 102 and the second colander 104 may be separated and disposed in open configurations and stored as individual colanders.

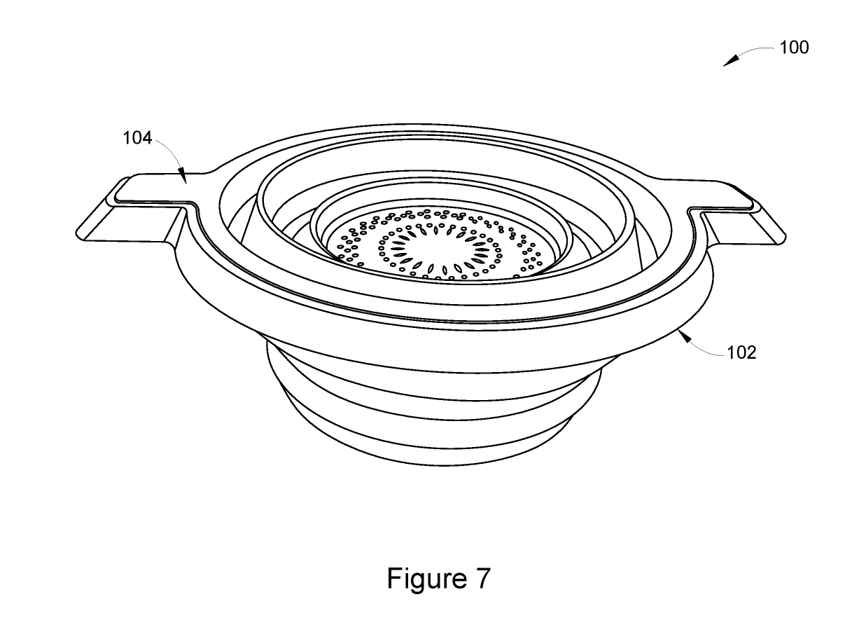

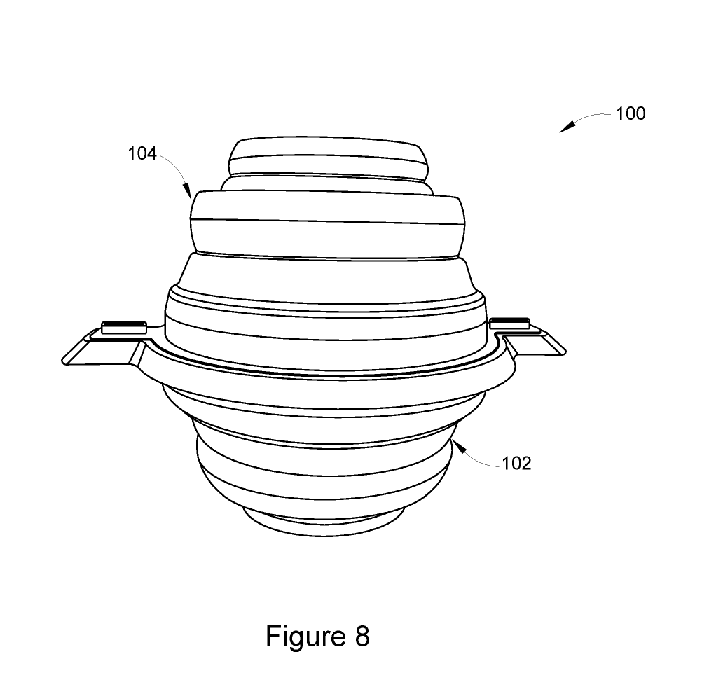

The straining arrangement 100 of the present disclosure may be utilized in multiple ways. In one example, the first colander 102 and the second colander 104 may be locked with each other and disposed in collapsed configurations (as shown in FIG. 1), to make the straining arrangement 100 compact for storage purposes and the like. In another example, the first colander 102 and the second colander 104 may be locked with each other and disposed in open configurations (as may be understood from FIG. 4), to utilize the straining arrangement 100 as a double strainer. In yet another example, the first colander 102 and the second colander 104 may be separated and disposed in open configurations (as shown in FIGS. 5A-5B and 6A-6B) to be utilized as individual colanders for straining of different sized items, or even for different purposes. In still another example, the first colander 102 is disposed in open configuration and the food items is placed therein and the second colander 104 is disposed in collapsed or partially collapsed configuration, and the first colander 102 and the second colander 104 are locked with each other (as shown in FIG. 7), such that the food items placed therebetween may be contained and shaken for preparation purposes. This allows a user to shake or strain food items without fear of the food falling out leading to better and sometime more vigorous straining. In still another example, the first colander 102 and the second colander 104 may be disposed in open configurations, with the second colander 104 being inverted and placed on top of the first colander 102 and locked with each other (as shown in FIG. 8) to create large internal volume for shaking food items therein, for straining and similar purposes. Other combinations of configurations and applications of the strainer arrangement 100 may be contemplated by a person skilled in the art without any limitations.

While the preferred embodiment of the present disclosure has been illustrated and described, as noted above, many changes can be made without departing from the spirit and scope of the present disclosure. Accordingly, the scope of the present disclosure is not limited by the disclosure of the preferred embodiment. Instead, the invention should be determined entirely by reference to the claims that follow.

What is claimed is:

1. A strainer arrangement comprising:
a first colander comprising a substantially rigid rim, the rim of the first colander providing at least one handle member, the at least one handle member of the rim of the first colander having an aperture formed therein; and
a second colander comprising a substantially rigid rim, the rim of the second colander providing at least one handle member, the at least one handle member of the rim of the second colander having a tab projecting from a bottom side thereof,
wherein the first colander and the second colander are of substantially same shape for stacking of the second colander into the first colander such that when stacked, the tab in the at least one handle member of the rim of the second colander engages with the aperture in the at least one handle member of the rim of the first colander for releasably locking the first colander and the second colander.

2. The strainer arrangement of claim 1, wherein the first colander further comprises a first vertical wall extending downwardly from the rim thereof.

3. The strainer arrangement of claim 2, wherein the at least one handle member of the rim of the first colander is extending radially outwardly from the first vertical wall.

4. The strainer arrangement of claim 2, wherein the first colander further comprises at least one flexible membrane supported and extending, downwardly and inwardly from the first vertical wall.

5. The strainer arrangement of claim 2, wherein the first colander further comprises:
a first flexible membrane supported from the first vertical wall;
a second vertical wall supported and extending downwardly from the first flexible membrane;
a second flexible membrane supported from the second vertical wall; and
a base member supported on the second flexible membrane, the base member having a plurality of holes formed therein,
wherein the first flexible membrane and the second flexible membrane are adapted to fold so as to dispose the first colander into a collapsed configuration and unfold to dispose the first colander into an open configuration.

6. The strainer arrangement of claim 1, wherein the second colander further comprises a first vertical wall extending downwardly from the rim thereof.

7. The strainer arrangement of claim 6, wherein the at least one handle member of the rim of the second colander is extending radially outwardly from the first vertical wall.

8. The strainer arrangement of claim 6, wherein the second colander further comprises at least one flexible membrane supported and extending, downwardly and inwardly from the first vertical wall.

9. The strainer arrangement of claim 6, wherein the second colander further comprises:
a first flexible membrane supported from the first vertical wall;
a second vertical wall supported and extending downwardly from the first flexible membrane;
a second flexible membrane supported from the second vertical wall; and
a base member supported on the second flexible membrane, the base member having a plurality of holes formed therein,
wherein the first flexible membrane and the second flexible membrane are adapted to fold so as to dispose the second colander into a collapsed configuration and unfold to dispose the second colander into an open configuration.

10. The strainer arrangement of claim 9, wherein the first colander is disposed in open configuration and the second colander is disposed in collapsed configuration, and the first colander and the second colander are releasably locked with each other to dispose the strainer arrangement for shaking purposes.

11. The strainer arrangement of claim 9, wherein the first colander and the second colander are disposed in open configurations, and the second colander is inverted and releasably locked with the first colander to dispose the strainer arrangement for shaking purposes.

12. The strainer arrangement of claim 1, wherein the first colander and the second colander are of substantially same size.

13. The strainer arrangement of claim 1, wherein the first colander is larger in size as compared to the second colander.

14. The strainer arrangement of claim 1, wherein the first colander and the second colander are substantially circular in shape.

15. The strainer arrangement of claim 1, wherein the first colander and the second colander include a plurality of holes in corresponding base members thereof.
